(19) United States
(12) Patent Application Publication
(10) Pub. No.: US 2022/0318457 A1
(43) Pub. Date: Oct. 6, 2022

(54) SIMULATION METHOD BASED ON EVENTS AND COMPUTER EQUIPMENT THEREOF

(71) Applicant: SHENZHEN ANTU AUTONOMOUS DRIVING TECHNOLOGIES LTD., Shenzhen (CN)

(72) Inventors: JIANXIONG XIAO, Shenzhen (CN); QIYI JIANG, Shenzhen (CN)

(21) Appl. No.: 17/708,012

(22) Filed: Mar. 30, 2022

(30) Foreign Application Priority Data
Mar. 30, 2021 (CN) 2021103437142

(51) Int. Cl. G06F 30/20

(52) U.S. Cl. CPC G06F 30/20; G06F 2119/02

(57) ABSTRACT

The disclosure provides an simulation method based on events including steps of: loading a virtual autonomous vehicle into a simulation scene; acquiring a first operation data of the virtual autonomous vehicle in the simulation scene, the first operation data is current operation data of autonomous vehicle; determining whether a first trigger event exists in the first operation data and the environment data or not; changing the first part of the obstacles from current movement trajectories to first movement trajectories according to a first predetermined movement rule when the first trigger event exists; acquiring second operation data of the virtual autonomous vehicle in the simulation scene; and obtaining simulation results of the autonomous driving system on the virtual autonomous vehicle in the simulation scene according to the second operation data. A computer equipment is also provided.

### CROSS REFERENCE TO RELATED APPLICATION

This non-provisional patent application claims priority under 35 U.S.C. § 119 from Chinese Patent Application No. 202110343714.2 filed on Mar. 30, 2021, the entire content of which is incorporated herein by reference.

### TECHNICAL FIELD

The disclosure relates to the field of autonomous driving technology, and in particular to a simulation method based on events, and a computer equipment using the simulation method.

### BACKGROUND

The obstacles used in a traditional simulation method are all move in a fixed path, and the obstacles move on a periodic trajectories without a brain periodically. The positions where the obstacles reach are only determined by movement time. It is difficult to construct desired scenes by the traditional simulation method that construct scenes only based on movement time. If some parameters of an autonomous driving system to be tested change, the current simulation scene may become meaningless. At the same time, it is also difficult to establish a large number of simulation scenes with large differences according to the traditional simulation methods, and it is easy to design a scene with small differences, and the simulation results generated in such a simulation scene with relatively small differences that it will be a lack of reference.

Therefore, there is a room in enlarging difference between the simulation scenes and making the simulation results more meaningful.

### SUMMARY

The disclosure provides a simulation method based on events, and computer equipment that can enlarge a difference between simulation scenes and make the simulation results more meaningful for reference.

A first aspect of the disclosure provides a simulation method based on events, the simulation method based on events includes steps of: loading a virtual autonomous vehicle into a simulation scene, and the virtual autonomous vehicle has an autonomous driving system to be tested, the simulation scene including environmental data and a plurality of obstacles, the plurality of obstacles moving in the simulation scene along a predetermined initial trajectories, and the plurality of the obstacles comprising a first part of the obstacles; acquiring a first operation data of the virtual autonomous vehicle in the simulation scene, the first operation data is current operation data of autonomous vehicle; determining whether a first trigger event exists in the first operation data and the environment data or not; changing the first part of the obstacles from current movement trajectories to first movement trajectories according to a first predetermined movement rule when the first trigger event exists; acquiring second operation data of the virtual autonomous vehicle in the simulation scene, the second operation data is all operation data of the virtual autonomous vehicle during the virtual autonomous vehicle performs one simulation; and obtaining simulation results of the autonomous driving system on the virtual autonomous vehicle in the simulation scene according to the second operation data.

A second aspect of the disclosure provides a computer equipment, the computer equipment includes a memory configured to store program instructions and a processor configured to execute the program instructions to enable the computer equipment to perform a simulation method based on events. The simulation method based on events includes steps of: loading a virtual autonomous vehicle into a simulation scene, and the virtual autonomous vehicle has an autonomous driving system to be tested, the simulation scene including environmental data and a plurality of obstacles, the plurality of obstacles moving in the simulation scene along a predetermined trajectories, and the plurality of the obstacles comprising a first part of the obstacles; acquiring a first operation data of the virtual autonomous vehicle in the simulation scene, the first operation data is current operation data of autonomous vehicle; determining whether a first trigger event exists in the first operation data and the environment data or not; changing the first part of the obstacles from current movement trajectories to first movement trajectories according to a first predetermined movement rule when the first trigger event exists; acquiring second operation data of the virtual autonomous vehicle in the simulation scene, the second operation data is all operation data of the virtual autonomous vehicle during the virtual autonomous vehicle performs one simulation; and obtaining simulation results of the autonomous driving system on the virtual autonomous vehicle in the simulation scene according to the second operation data.

The simulation method and computer equipment described above can load the autonomous driving system to be tested into the simulation scene, and change the first part of the obstacles from the current motion trajectory to the first motion trajectory through the first trigger event. The complexity of the simulation scene is increased, the pertinence of the simulation scene is enhanced, and the effectiveness of the simulation is improved. By changing the second part of the obstacles from the current motion trajectory to the preset second motion trajectory through the second trigger event, not only the automatic driving vehicle and the environment trigger the change of the obstacle behavior, but the obstacles can also affect each other, which improves the complexity of the simulation scene and makes the simulation scene closer to the actual vehicle or pedestrian response, and the simulation results have reference significance that it is better to evaluate the automated driving system.

### BRIEF DESCRIPTION OF THE DRAWINGS

FIG. 1 is a flow chart of an simulation method based on events in accordance with a first embodiment.

FIG. 2 is a flowchart of the simulation method based on events in accordance with a second embodiment.

FIG. 3 is a first sub flowchart of the simulation method based on events in accordance with a first embodiment of the present invention.

FIG. 4 is a second sub flowchart of the simulation method based on events In accordance with a first embodiment.

FIG. 5 is a third sub flowchart of the simulation method based on events in accordance with a first embodiment.

FIG. 6 is a fourth sub flowchart of the simulation method based on events in accordance with a first embodiment.

FIG. 7 is a fifth sub flowchart of the simulation method based on events in accordance with a first embodiment.

FIG. 8 is a sixth sub flowchart of the simulation method based on events in accordance with a first embodiment.

FIG. 9 is a second sub flowchart of the simulation method based on events in accordance with a second embodiment.

FIG. 10 is a schematic diagram of the internal structure of an computer equipment for simulating an autonomous driving system base on event.

The labeling of each The realization of the object, functional features and advantages of the invention will be further described with reference to the attached drawings in combination with the embodiment.

### DETAILED DESCRIPTION OF THE EMBODIMENTS

In order to make purpose, technical solution and advantages of the disclosure more clearly, the disclosure is further described in detail in combination with drawings and embodiments. It is understood that the specific embodiments described herein are used only to explain the disclosure and are not used to define it. On the basis of the embodiments in the disclosure, all other embodiments obtained by ordinary technicians in this field without any creative effort are covered by protection of the disclosure.

Terms “first”, “second”, “third”, “fourth”, if any, in specification, claims and drawings of this application are used to distinguish similar objects and need not be used to describe any particular order or sequence of priorities. It should be understood that data are interchangeable when appropriate, in other words, the embodiments described can be implemented in order other than what is illustrated or described here. In addition, terms “include” and “have” and any variation of them, can encompass other things. For example, processes, methods, systems, products, or equipment that comprise a series of steps or units need not be limited to those clearly listed, but may include other steps or units that are not clearly listed or are inherent to these processes, methods, systems, products, or equipment.

It is to be noted that description refers to “first”, “second”, etc. in the disclosure are for descriptive purpose only and neither be construed or implied relative importance nor indicated as implying number of technical features. Thus, feature defined as “first” or “second” can explicitly or implicitly include one or more features. In addition, technical solutions between embodiments may be integrated, but only on the basis that they can be implemented by ordinary technicians in this field. When the combination of technical solutions is contradictory or impossible to be realized, such combination of technical solutions shall be deemed to be non-existent and not within the scope of protection required by the disclosure.

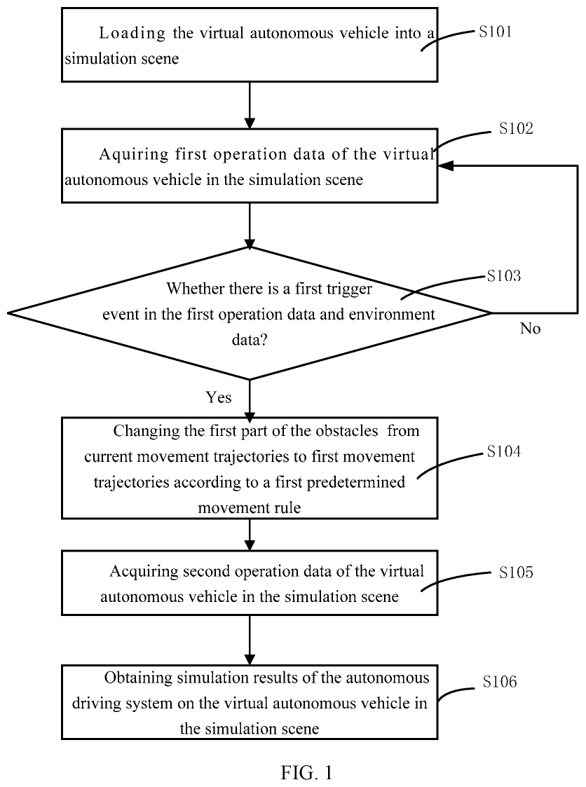

Referring to FIG. 1, the FIG. 1 illustrates a flowchart of a simulation method based on event in accordance with a first embodiment. The simulation method based on events includes following steps of S101-S106.

In the step S101, the virtual autonomous vehicle is loaded into a simulation scene. The virtual autonomous vehicle has an autonomous driving system to be tested. The simulation scene includes environmental data and a plurality of obstacles, and the plurality of obstacles move in the simulation scene according to predetermined initial trajectories. The plurality of obstacles include a first part of the obstacles. In detail, the autonomous driving system to be tested is an autonomous vehicle simulation system. The autonomous driving system includes a plurality of independent autonomous driving units, such as a car body model unit, a tire model unit, a brake system model unit, a steering system model unit, a power system model unit, a transmission system model unit, an aerodynamic model unit, and a hardware IO interface model unit, etc.

The simulation scene is a virtual environment with all test elements and specific characteristic. The simulation scene can be represented through semantic and relationships among the autonomous driving system, the plurality of obstacles, and environment in the domain can be described through language scene symbols. The environmental data includes road scenes, traffic scenes, and natural environmental scenes. Taking road scenes as an example, the road scenes including environmental data such as the number of lanes, slope, exits, roadblocks, and road conditions. Taking the traffic scenes as an example, the traffic scene includes environmental data such as the number and speed of other traffic participants and other drivers. Taking the natural environmental scenes as an example, the natural environmental scenes includes visibility and weather conditions. The obstacles are data models including pedestrians, vehicles, roadblocks and other objects that may affect the driving of autonomous vehicles.

Further, the virtual autonomous vehicle to be loaded into the simulation scene is equivalent to the autonomous vehicle in a predetermined realistic environment, and the autonomous driving system of a real autonomous vehicle can be analyzed by analyzed driving performances of the virtual autonomous vehicle.

In the step S102, first operation data of the virtual autonomous vehicle in the simulation scene is acquired. In detail, how to obtain the first operation data will described in steps S1021 to S1023 to obtain all obstacles in the first operation data scene and move according to a predetermined time rule. For example, FIG. 11 illustrates the simulation scene that the virtual autonomous vehicle 100 drives in parallel with an obstacles vehicle 101. At this time, the obstacles vehicle 101 moves periodically along predetermined initial trajectories according to movement time, and the data obtained at this time is the first operation data.

In the step S103, it is determined that whether there is a first trigger event in the first operation data and environment data. How to determine whether the first trigger event exist or not will described in detail from steps S1031 to S1034. For example, a red light at an intersection is the first trigger event. When there is the first trigger event, it enters into the step S104, otherwise it returns to the step S102.

In the step S104, the first part of the obstacles are changed from the current movement trajectories to first movement trajectories when there is the first trigger event. In other words, the first movement trajectories are the movement trajectories of the first part of the obstacles performed according to the first predetermined movement rule when the first trigger event appear. For example, taking the pedestrians' and other vehicles as the first part of the obstacles, taking red lights at the intersection as the first trigger event, when the red lights are lighted in the simulation scene, the first part of the obstacles' movement trajectories are to stand still according to the predetermined initial trajectories, otherwise the pedestrians and other vehicles will move across in front of the virtual autonomous vehicle according to the first movement trajectories. In other words, the pedestrians and other vehicles is triggered to move across in front of the virtual autonomous vehicle other than to stand still when the red light at the intersection is lighted.

In step S105, the second operation data of the virtual autonomous vehicle in the simulation scene is obtained. It is understood that the second operation data is the data generated when the virtual autonomous vehicle moves in the first movement trajectories in the simulation scene. In other words, the second operation data is the data generated when the virtual autonomous vehicle are driving in conditions that the obstacles appearing suddenly.

In step S106, simulation results of the autonomous driving system on the virtual autonomous vehicle in the simulation scene is obtained according to the second operation data. In detail, simulation data for the autonomous driving system to handle sudden obstacles is obtained, and the simulation data is capable of evaluating to be valid or not, and to be advantages and disadvantages of the autonomous driving system.

In the above embodiments, the autonomous driving system is loaded into the simulation scene, and the first part of the obstacles are changed from the current moving trajectories to the first moving trajectories based on the first triggering event. It increases the complexity of the simulation scene, enhances the pertinence of the simulation scene and improves the effectiveness of the simulation.

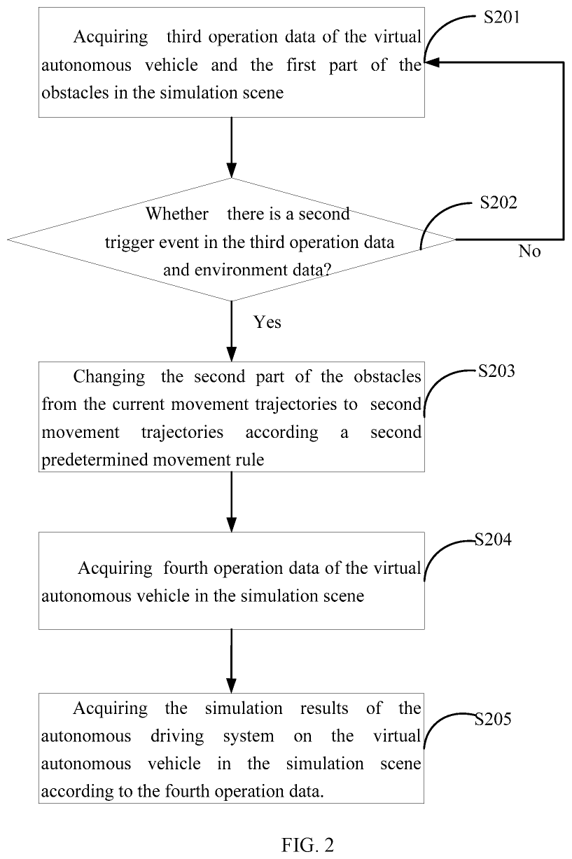

Referring to FIG. 2, FIG. 2 illustrates the simulation method based on events in accordance with a second embodiment. A difference between the simulation method based on events in accordance with the second embodiment and the simulation method based on events in accordance with the first embodiment is that the plurality of obstacles further include second part of obstacles. The simulation method based on events in the second embodiment further includes steps of S201-S205.

In the step S201, third operation data of the virtual autonomous vehicle and the first part of the obstacles in the simulation scene is acquired. In detail, the third operation data includes operation data of the virtual autonomous vehicle and the operation data of the first part of the obstacles.

In the step S202, it is determined that whether there is a second trigger event in the third operation data and environment data. In detail, the second trigger event is a event triggering movement trajectories obstacles to change for the second time. The second trigger event further includes the behavior of the obstacles. For example, when an obstacles vehicle has a traffic accident and other obstacles vehicles receive the trigger event, they will also change an initial movement trajectories to be closer to an actual situation. When there is a second trigger event, it enters into the step S203, otherwise, it return to the step S201.

In step S203, the second part of the obstacles are changed from the current movement trajectories to second movement trajectories according a second predetermined movement rule when there is the second trigger event. In detail, the predetermined second movement trajectories are the movement trajectories along which the second part of the obstacles move according to the second trigger event. For example, it is desired to detect a performance of the autonomous driving system to process sudden obstacles when the autonomous vehicle crosses crossroads. The second part of the obstacles are pedestrians, the second trigger event is green lights at the crossroads are lighted in the simulation scene. In a simulation scene, the virtual autonomous vehicle is ready to cross the zebra crossing and the green lights at the crossroads are lighted, the pedestrians will appear at a distance from the autonomous vehicle, and cross the road at a predetermined speed according to the second predetermined movement rule. In other words, the pedestrians will not appear when the green lights at the crossroads are lighted according to the predetermined initial trajectories. In this embodiment, when the pedestrians will not appear when the green lights at the crossroads are lighted according to the second movement trajectories.

In the step S204, fourth operation data of the virtual autonomous vehicle in the simulation scene is acquired.

In the step S205, simulation results of the autonomous driving system on the virtual autonomous vehicle in the simulation scene is acquired according to the fourth operation data. In detail, the simulation data for the autonomous driving system to handle sudden obstacles is obtained, and the simulation data is capable of evaluating to be valid or not, and to be advantages and disadvantages of the autonomous driving system.

In this embodiment, the second part of obstacles are changed from the current movement trajectories to the predetermined second movement trajectories based on the second trigger event which not only triggers the change of the obstacles behavior by the autonomous vehicle and the environment, but also affects each other of the obstacles. It will improve a complexity of the simulation scene, makes the simulation scene closer to a response of vehicles or pedestrians in practice, and makes the simulation results have reference significance. Therefore, it is better to evaluate the autonomous driving system.

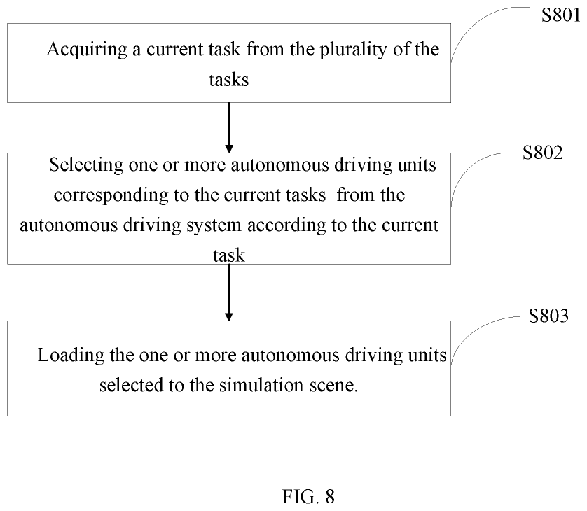

Referring to FIG. 8, it illustrates a sub-flowchart of step S101 in accordance with a first embodiment. The autonomous driving system includes a plurality of tasks can be detect independently by corresponding autonomous driving units. The step S101 of loading the autonomous driving system to the simulation scene further includes following steps of S801-S803.

In step S801, current task from the plurality of tasks. In detail, the tasks to be tested can be detection of driving units of the autonomous vehicles, such as a tire model unit, a braking system model unit and a steering system model unit and so on. The tasks to be tested can also be detection of extreme conditions, such as thunderstorm weather environment, Blizzard environment, etc.

In the step S802, one or more autonomous driving units corresponding to the current task is selected from the autonomous driving system. In detail, if the tasks are to test a performance of the tire module, only the tire model unit of the autonomous driving system can be loaded to analyze. If the current task is to test a performance for the autonomous driving system responding to thunderstorm weather environment, all the autonomous driving units can be loaded to analyze.

In the step S803, one or more autonomous driving units selected are loaded to the simulation scene. It is understood that, it is to load the corresponding autonomous driving unit to the simulation scene according to the actual situation.

In the above embodiment, only the autonomous driving unit to be detected are loaded, which saves computing power and improves the simulation efficiency It can realize the effect of simulation test faster and better, and realize the flexible application of simulation scene.

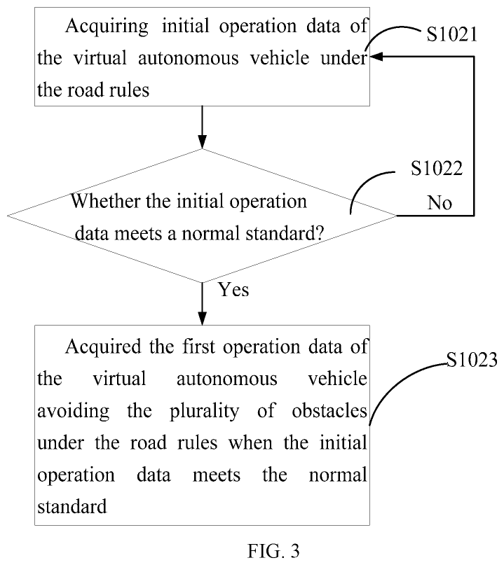

Referring to FIG. 3, FIG. 3 illustrates a sub-step flowchart of step S102 in accordance with a first embodiment of the present invention. In the step S102, the environmental data include road rules, the step S102 of obtaining the first operation data of the autonomous driving system to be tested in the simulation scene includes following steps S1021-S1023.

In the step S1021, initial operation data of the virtual autonomous vehicle under road rules is acquired.

In the step S1022, it is determined whether the initial operation data meets a normal standard. When the initial operation data meets a normal standard, it enters into the step S1023, otherwise it returns to the step S1021.

In the step S1023, the first operation data of the virtual autonomous vehicle avoiding the plurality of obstacles under the road rules is acquired when the initial operation data meets the normal standard.

In the above embodiment, the performance of the autonomous driving system to be tested under the road rules is detected first, so that it is ensure that the autonomous driving vehicle system is equipped with normal, functions and prevent the simulation effect of the autonomous driving system from being meaningless because of the autonomous driving system in abnormal.

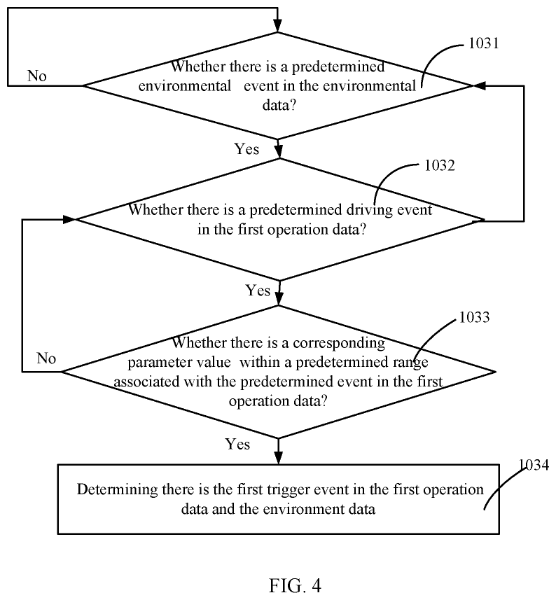

Referring to FIG. 4, FIG. 4 illustrates a sub-step flowchart of step S103 in accordance with a first embodiment. The step S103 of determining whether there is a first trigger event in the first operation data and environment data includes following steps S1031-S1034.

In the step S1031, it is determined whether there is a predetermined environmental event in the environmental data or not. For example, the red light instruction of traffic lights, or the speed limit instruction of some roads, etc. When there is a predetermined environment event, it enters into the step S1032, otherwise returns to the step S1031.

In step S1032, when there is a predetermined environment event, it is determined whether there is a predetermined driving event in the first operation data or not. For example, when a traffic light is at a red light, there is a slowdown or parking instruction in the autonomous driving system, the predetermined driving event is determined to exist in the first operation data. When a traffic light is at a red light, there is not a slowdown or either parking instruction in the autonomous driving system, the predetermined driving event is determined to not exist in the first operation data. When there is a predetermined driving event in the first operation data, it enters into the step S1033, otherwise returns to the step S1031.

In the step S1033, when there is the predetermined driving event, it is determined whether there is a corresponding parameter value within a predetermined range associated with the predetermined driving event in the first operation data. For example, when a green light is at the traffic light, there is a slowing down instruction for the autonomous driving system, and the predetermined range is used to determine whether the speed of the autonomous driving system is really available at this time. In detail, when the speed of the self driving vehicle is within the predetermined range the speed of the autonomous driving system is available. And otherwise, the speed of the autonomous driving system is not available. When there is the corresponding parameter value within the predetermined range associated with the predetermined event in the first operation data, it enters into the step S1034, otherwise return to the step S1032.

In the step S1034, it is determined that there is the first trigger event in the first operation data and the environment data.

In the above embodiment, starting from the meaning of the environmental command in the scene, judge whether the behavior of the autonomous vehicle in the simulation scene meets the predetermined conditions to trigger the specified obstacles behavior, so as to make the simulation scene more targeted and the simulation results more referential.

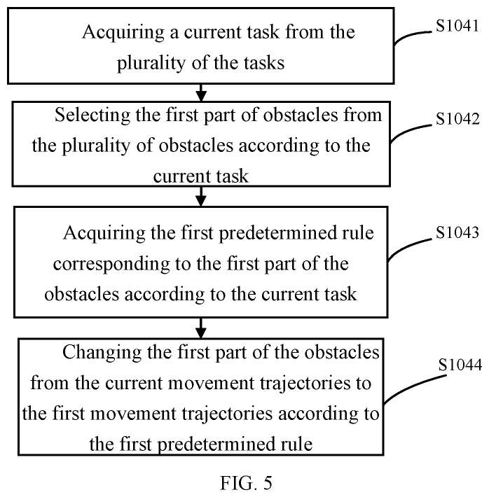

Referring to FIG. 5, FIG. 5 illustrates a sub-step flowchart of step S104 in accordance with a first embodiment. The autonomous driving system to be tested includes a plurality of tasks to be tested. The step S104 of changing the first part of the obstacles from the current movement trajectories to the first movement trajectories includes following steps of S1041-S1044.

In the step S1041, a current task is acquired from the plurality of the tasks.

In the step S1042, the first part of obstacles are selected from a plurality of obstacles according to the current task. In detail, one or more pedestrian obstacles should be selected when a respond to the green lights of the autonomous driving system needs to be detected while pedestrians cross the road.

In the step S1043, the first predetermined movement rule corresponding to the first part of the obstacles is acquired according to the current task. The first predetermined movement rule is a rule being set according to parameters to be detected in the tasks to be tested. For example, a speed, an acceleration, and a position.

In the step S1044, the first part of the obstacles are changed from the current movement trajectories to the first movement trajectories according to the first predetermined movement rule. The first movement trajectories is the trajectories of the obstacles different from the predetermined initial trajectories. In detail, the first movement trajectories of one or more pedestrians crossing the road is calculated. In detail, when the autonomous driving vehicle appears near the zebra crossing, the pedestrians waiting on the roadside according to the predetermine rule cross the road at the set speed according to the movement trajectories.

In the above embodiment, after the trigger event appears, one or more selected obstacles change the movement trajectories, increase the diversity of the simulation scene, and provide a variety of possibilities for the simulation scene. It provides more possibilities for the autonomous driving system to be tested, and enhances the diversity of simulation results.

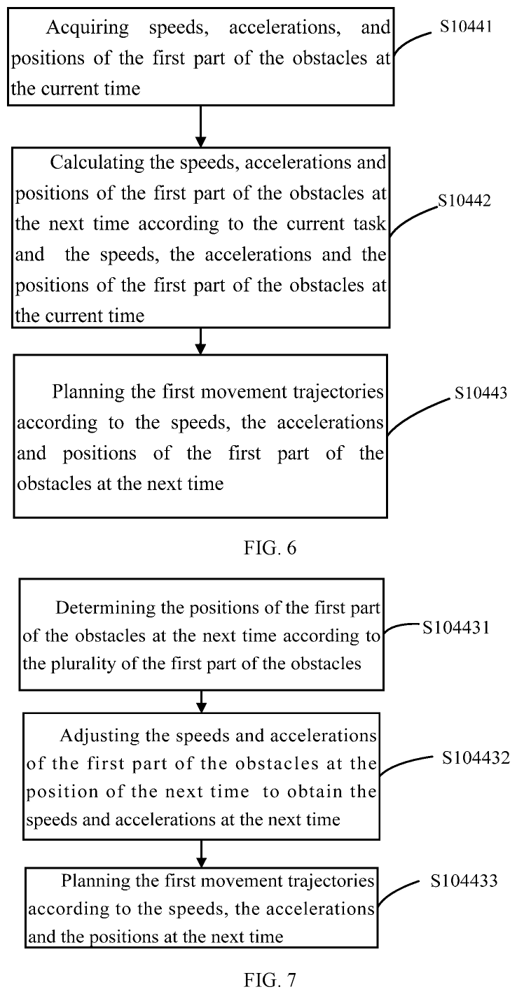

Referring to FIG. 6, FIG. 6 illustrates a sub-step flowchart of step S1044 in accordance with the first embodiment of the present invention. The step S1044 of changing the first part of the obstacles from the current movement trajectories to the first movement trajectories according to the first predetermined movement rule includes the following steps S10441-S10442.

In step the S10441, speeds, accelerations and positions of the first part of the obstacles at current time are acquired. For example, walking speeds of the pedestrians, the positions among the pedestrians are calculated.

In step the S10442, speeds, accelerations and positions of the first part of the obstacles at the next time are calculated according to the current task and the speeds, the accelerations and the positions of the first part of the obstacles at the current time.

In step the S10443, the first movement trajectories is planned according to the speeds, the accelerations and positions of the first part of the obstacles at the next time.

Referring to FIG. 7, FIG. 7 illustrates a sub-step flowchart of step S10443 in accordance with a first embodiment of the present invention. The step S10443 of planning the first movement trajectories according to the speeds, accelerations and positions of the first part of the obstacles at the next time includes the following steps.

In step the S104431, the positions of the first part of the obstacles at the next time are determined according to the plurality of the first part of the obstacles.

In step the S104432, the speeds and accelerations of the first part of the obstacles at the positions at the next time are adjusted to obtain the speeds and accelerations of the next time.

In step the S104433, the first movement trajectories are planned according to the speeds, the accelerations and the positions at the next time.

In the above examples, the behavior of obstacles is affected not only by the environmental data and the behavior of the autonomous driving system, but also by the related obstacles. The interactions between obstacles are more consistent with the actual situation, making the simulation environment more realistic, and the simulation results have a better reference effect.

In the above embodiment, starting from the environmental in the scene, it determines whether the behavior of the autonomous vehicle in the simulation scene meets the predetermined conditions and triggers the specified obstacles behavior, so as to make the simulation scene more targeted and the simulation results more referential.

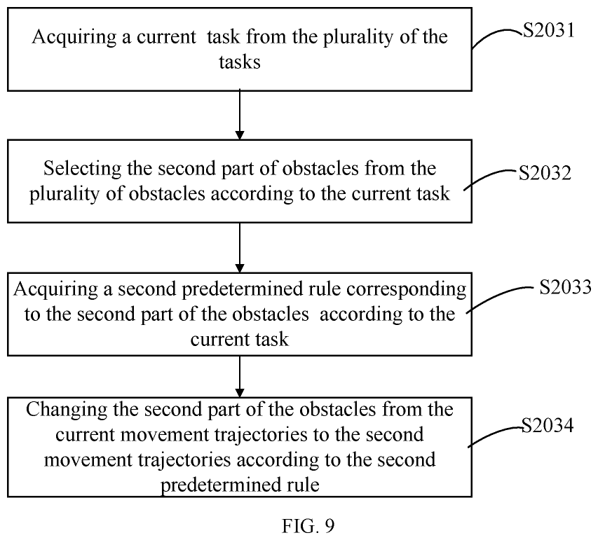

Referring to FIG. 9, FIG. 9 illustrates a sub step flowchart of step S203 in accordance with the first embodiment of the present invention. The autonomous driving system includes a plurality of tasks to be tested. The step S203 of changing the second part of the obstacles from the current movement trajectories to the predetermined second movement trajectories. includes following steps of step S2031-S2034.

In the step S2032, a current task is acquired from the plurality of the tasks.

In the step S2032, the second part of obstacles are selected from the plurality of obstacles according to the current task.

In the step S2033, a second predetermined movement rule corresponding to the second part of the obstacles is obtained according to the tasks to be tested. The second predetermined movement rule is the rule being set according to parameters to be detected in the tasks. For example, the parameters may be speeds, accelerations, and positions of the second part of the obstacles and so on.

In the step S2034, the second part of the obstacles are changed from the current movement trajectories to the second movement trajectories according to the second predetermined movement rule.

In the above embodiment, one or more selected obstacles change the movement trajectories after the trigger event appears, and the interaction between obstacles increases the diversity of the simulation scene and provides a variety of possibilities for the simulation scene. It provides more possibilities for the autonomous driving system to be tested, and enhances the diversity of simulation results.

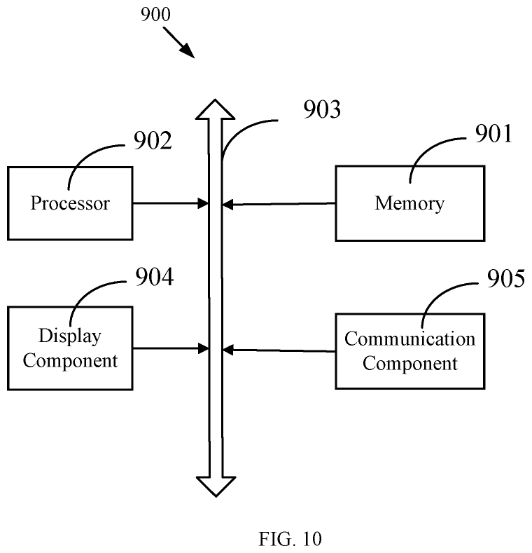

The first embodiment of the invention provides a computer equipment 900, which includes a memory 901 for storing program instructions of an simulation method based on events, a processor 902 for executing program instructions to enable the computer equipment to implement the above simulation method based on events. FIG. 10 illustrates a schematic diagram of the internal structure of the computer equipment 900 provided by the first embodiment of the present invention. The computer equipment 900 includes at least a memory 901 and a processor 902.

The memory 901 includes at least one type of readable storage medium, which includes flash memory, hard disk, multimedia card, card memory (E. G., SD or DX memory, etc.), magnetic memory, magnetic disk, optical disc, etc. In some embodiments, the memory 901 may be an internal storage unit of the computer equipment 900, such as a hard disk of the computer equipment 900. In other embodiments, the memory 901 may also be an external storage device of the computer equipment 900, such as a plug-in hard disk, smart media card (SMC), secure digital (SD), flash card, etc. equipped on the computer equipment 900. Further, the memory 901 may also include both an internal storage unit of the computer equipment 900 and an external storage device. The memory 901 can be used not only to store the application software installed on the computer equipment 900 and various kinds of data, such as program instructions for the simulation method based on the events, but also to temporarily store the data that has been output or will be output. For example, simulation results.

In some embodiments, the processor 902 may be a central processing unit (CPU), controller, microcontroller, microprocessor or other data processing chip for running program instructions or processing data stored in the memory 901. In detail, the processor 902 executes program instructions of the event simulation method to control the computer equipment 900 to implement the event simulation method. The above embodiment has described in detail the program instructions of the event simulation method executed by the processor 902 in the computer equipment 900 to control the detailed process of the computer equipment 900 implementing the event simulation method, which will not be repeated here.

Further, the bus 903 may be a peripheral component interconnect (PCI) or an extended industry standard architecture (EISA). The bus can be divided into address bus, data bus, control bus and so on. For ease of representation, only one thick line is used in FIG. 10, but it does not mean that there is only one bus or one type of bus.

Further, the computer equipment 900 may also include a display component 904. The display component 904 may be an LED (light emitting diode) display, a liquid crystal display, a touch liquid crystal display, an OLED (organic light emitting diode) touch device, etc. The display component 904 may also be appropriately referred to as a display device or display unit for displaying information processed in the computer equipment 900 and a user interface for displaying visualization.

Further, the computer equipment 900 may also include a communication component 905, which may optionally include wired communication components and/or wireless communication components (such as Wi-Fi communication components, Bluetooth communication components, etc.), which are usually used to establish a communication connection between the computer equipment 900 and other computer equipments.

FIG. 10 shows only the computer equipment 900 with components 901-905 and program instructions implemented in the event simulation method. It can be understood by those skilled in the art that the structure shown in FIG. 10 does not constitute a limitation on the computer equipment 900, and may include fewer or more components than shown in the figure, or a combination of some components, or different component arrangements.

In some embodiments, the processor 802 may be a central processing unit (Central Processing Unit, CPU), controller, microcontroller, microprocessor, or other data processing chip, for executing program codes or processing stored in the memory 801 data.

In the above-mentioned embodiments, it may be implemented in whole or in part by software, hardware, firmware or any combination thereof. When implemented in software, it can be implemented in whole or in part in the form of a computer program product.

The computer program product includes one or more computer instructions. When the computer program instructions are loaded and executor on a computer, a process or function according to the embodiment of the disclosure is generated in whole or in part. The computer equipment may be a general-purpose computer, a dedicated computer, a computer network, or other programmable device. The computer instruction can be stored in a computer readable storage medium, or transmitted from one computer readable storage medium to another computer readable storage medium. For example, the computer instruction can be transmitted from a web site, computer, server, or data center to another web site, computer, server, or data center through the cable (such as a coaxial cable, optical fiber, digital subscriber line) or wireless (such as infrared, radio, microwave, etc.). The computer readable storage medium can be any available medium that a computer can store or a data storage device such as a serve or data center that contains one or more available media integrated. The available media can be magnetic (e.g., floppy Disk, hard Disk, tape), optical (e.g., DVD), or semiconductor (e.g., Solid State Disk), etc.

The technicians in this field can clearly understand the specific working process of the system, device and unit described above, for convenience and simplicity of description, can refer to the corresponding process in the embodiment of the method described above, and will not be repeated here.

In the several embodiments provided in this disclosure, it should be understood that the systems, devices and methods disclosed may be implemented in other ways. For example, the device embodiments described above is only a schematic. For example, the division of the units, just as a logical functional division, the actual implementation can have other divisions, such as multiple units or components can be combined with or can be integrated into another system, or some characteristics can be ignored, or does not perform. Another point, the coupling or direct coupling or communication connection shown or discussed may be through the indirect coupling or communication connection of some interface, device or unit, which may be electrical, mechanical or otherwise.

The unit described as a detached part may or may not be physically detached, the parts shown as unit may or may not be physically unit, that is, it may be located in one place, or it may be distributed across multiple network units. Some or all of the units can be selected according to actual demand to achieve the purpose of this embodiment scheme.

In addition, the functional units in each embodiment of this disclosure may be integrated in a single processing unit, or may exist separately, or two or more units may be integrated in a single unit. The integrated units mentioned above can be realized in the form of hardware or software functional units.

The integrated units, if implemented as software functional units and sold or used as independent product, can be stored in a computer readable storage medium. Based on this understanding, the technical solution of this disclosure in nature or the part contribute to existing technology or all or part of it can be manifested in the form of software product. The computer software product stored on a storage medium, including several instructions to make a computer equipment (may be a personal computer, server, or network device, etc.) to perform all or part of steps of each example embodiments of this disclosure. The storage medium mentioned before includes U disk, floating hard disk, ROM (Read-Only Memory), RAM (Random Access Memory), floppy disk or optical disc and other medium that can store program codes.

It should be noted that the embodiments number of this disclosure above is for description only and do not represent the advantages or disadvantages of embodiments. And in this disclosure, the term “including”, “include” or any other variants is intended to cover a non-exclusive contain. So that the process, the devices, the tasks, or the methods includes a series of elements not only include those elements, but also include other elements not clearly listed, or also include the inherent elements of this process, devices, tasks, or methods. In the absence of further limitations, the elements limited by the sentence “including a . . . ” do not preclude the existence of other similar elements in the process, devices, tasks, or methods that include the elements.

The above are only the preferred embodiments of this disclosure and do not therefore limit the patent scope of this disclosure. And equivalent structure or equivalent process transformation made by the specification and the drawings of this disclosure, either directly or indirectly applied in other related technical fields, shall be similarly included in the patent protection scope of this disclosure.

1. A simulation method based on events, comprising:
loading a virtual autonomous vehicle into a simulation scene, and the virtual autonomous vehicle has an autonomous driving system to be tested, the simulation scene including environmental data and a plurality of obstacles, the plurality of obstacles moving in the simulation scene along a predetermined initial trajectories, and the plurality of the obstacles comprising a first part of the obstacles;
acquiring first operation data of the virtual autonomous vehicle in the simulation scene;
determining whether a first trigger event exists in the first operation data and the environment data or not;
changing the first part of the obstacles from current movement trajectories to first movement trajectories according to a first predetermined movement rule when the first trigger event exists;
acquiring second operation data of the virtual autonomous vehicle in the simulation scene; and
obtaining simulation results of the autonomous driving system on the virtual autonomous vehicle in the simulation scene according to the second operation data.

2. The simulation method based on events of claim 1, wherein the plurality of obstacles further comprises a second part of obstacles, and the simulation method based on events, further comprises:
acquiring third operation data of the virtual autonomous vehicle and first part of obstacles in the simulation scene, the third operation data is current operation data of the virtual autonomous vehicle and the first part of obstacles in the simulation scene;
determining whether a second trigger event exists in the third operation data and the environment data;
changing the second part of the obstacles from current movement trajectories to second movement trajectories according to a second predetermined movement rule when the second trigger event exists;
acquiring fourth operation data of the virtual autonomous vehicle in the simulation scene; and
obtaining the simulation results of the autonomous driving system on the virtual autonomous vehicle in the simulation scene according to the second operation data.

3. The simulation method based on events of claim 1, wherein the environmental data includes road rules, obtaining the first operation data of the virtual autonomous vehicle in the simulation scene, comprising:
acquiring initial operation data of the virtual autonomous vehicle under the road rules;
determining whether the initial operation data meets a normal standard or not;
acquiring the first operation data of the virtual autonomous vehicle avoiding the plurality of obstacles according to the road rules when the initial operation data meets the normal standard.

4. The simulation method based on events of claim 1, wherein the first trigger event includes a predetermined environment event, and a predetermined driving event, and determining whether there is the first trigger event in the first operation data and the environment data comprises:
determining whether the predetermined environmental event exists in the environmental data or not;
determining whether the predetermined driving event in the first operation data when the predetermined environment event exists;
determining whether there is a corresponding parameter value within a predetermined range associated with the predetermined event in the first operation data, when the predetermined driving event exists; and
determining there is the first trigger event in the first operation data and the environment data, when there is the corresponding parameter value within the predetermined range associated with the predetermined event in the first operation data.

5. The simulation method based on events of claim 1, wherein the autonomous driving system includes tasks to be tested, changing the first part of the obstacles from current movement trajectories to first movement trajectories according to the first predetermined movement rule when the first trigger event exists comprises:
acquiring a current task from the plurality of the tasks;
selecting the first part of obstacles from the plurality of obstacles according to the the current task;
acquiring the first predetermined movement rule corresponding to the first part of the obstacles according to the current task; and
changing the first part of the obstacles from the current movement trajectories to the first movement trajectories according to the first predetermined movement rule.

6. The simulation method based on events of claim 5, wherein changing the first part of the obstacles from the current movement trajectories to the first movement trajectories according to the first predetermined movement rule comprises:
acquiring speeds, accelerations, and positions of the first part of the obstacles at the current time;
calculating speeds, accelerations and positions of the first part of the obstacles at the next time according to the current task, and the speeds, the accelerations and the positions of the first part of the obstacles at the current time; and
planning first movement trajectories of the first part of the obstacles according to the speeds, the accelerations and the positions of the first part of the obstacles at the next time.

7. The simulation method based on events of claim 6, wherein planning first movement trajectories of the first part of the obstacles according to the speeds, the accelerations and the positions of the first part of the obstacles at the next time comprises:
determining the positions of the first part of the obstacles at the next time according to the number of the first part of the obstacles;
adjusting the speeds and the accelerations of the obstacles at the positions at the next time to obtain speeds and accelerations at the next time; and
planning first movement trajectories of the first part of the obstacles according to the adjusted speeds, the adjusted accelerations, and the determined positions.

8. The simulation method based on events of claim 1, wherein the autonomous driving system includes a plurality of tasks to be tested being performed independently by one or more corresponding autonomous driving units loading the virtual autonomous vehicle to the simulation scene comprises:
acquiring a current task from the plurality of the task;
selecting one or more of the autonomous driving units corresponding to the current task; and
loading the corresponding one or more of the autonomous driving units to the simulation scene.

9. The simulation method based on events of claim 2, wherein the autonomous driving system includes a plurality of tasks to be tested, changing the second part of the obstacles from current movement trajectories to the second movement trajectories according to a second predetermined movement rule comprises:
acquiring a current task; from the plurality of the tasks;
selecting the second part of obstacles from the plurality of obstacles according to the current task;
calculating a corresponding second predetermined movement rule of the second part of the obstacles according to the current task, and
changing the second part of the obstacles from the current movement trajectories to the second movement trajectories according to the second predetermined movement rule.

10. The simulation method based on events of claim 1, wherein the first event is that traffic lights change; the second event is that the first part of the obstacles do not follow traffic rules.

11. A computer equipment, comprises:
a memory for storing program instructions of the simulation method based on events; and
a processor for executing the program instructions to enable the computer equipment to implement the simulation method based on events, the simulation method based on events comprising:
loading a virtual autonomous vehicle into a simulation scene, and the virtual autonomous vehicle has an autonomous driving system to be tested, the simulation scene including environmental data and a plurality of obstacles, the plurality of obstacles moving in the simulation scene along a predetermined initial trajectories, and the plurality of the obstacles comprising a first part of the obstacles;
acquiring a first operation data of the virtual autonomous vehicle in the simulation scene;
determining whether a first trigger event exists in the first operation data and the environment data or not;
changing the first part of the obstacles from current movement trajectories to first movement trajectories according to a first predetermined movement rule when the first trigger event exists;
acquiring second operation data of the virtual autonomous vehicle in the simulation scene; and
obtaining simulation results of the autonomous driving system on the virtual autonomous vehicle in the simulation scene according to the second operation data.

12. The computer equipment of claim 11, wherein the plurality of obstacles further comprises a second part of obstacles, and the simulation method based on events, further comprises:
acquiring third operation data of the virtual autonomous vehicle and first part of obstacles in the simulation scene, the third operation data is current operation data of the virtual autonomous vehicle and the first part of obstacles in the simulation scene;
determining whether a second trigger event exists in the third operation data and the environment data; and
changing the second part of the obstacles from current movement trajectories to second movement trajectories according to a second predetermined movement rule when the second trigger event exists;
acquiring fourth operation data of the virtual autonomous vehicle in the simulation scene; and
obtaining the simulation results of the autonomous driving system on the virtual autonomous vehicle in the simulation scene according to the second operation data.

13. The computer equipment of claim 11, wherein the environmental data includes road rules, obtaining the first operation data of the virtual autonomous vehicle in the simulation scene, comprising:
acquiring initial operation data of the virtual autonomous vehicle under the road rules;
determining whether the initial operation data meets a normal standard or not;
the first operation data of the virtual autonomous vehicle avoiding the plurality of obstacles according the road rules. when the initial operation data meets the normal standard.

14. The computer equipment of claim 11, wherein the first trigger event includes a predetermined environment event, and a predetermined driving event, and determining whether a second trigger event exists in the third operation data and the environment data comprises:
determining whether the predetermined environmental event exists in the environmental data or not;
determining whether the predetermined driving event in the first operation data when the predetermined environment event exists;
determining whether there is a corresponding parameter value within a predetermined range associated with the predetermined event in the first operation data, when the predetermined driving event exists; and
determining there is the first trigger event in the first operation data and the environment data, when there is the corresponding parameter value within the predetermined range associated with the predetermined event in the first operation data.

15. The computer equipment of claim 11, wherein the autonomous driving system includes a plurality of tasks to be tested being performed independently by one or more corresponding autonomous driving units, changing the first part of the obstacles from current movement trajectories to first movement trajectories according to a first predetermined movement rule when the first trigger event exists comprises:
acquiring a current task from the plurality of the tasks;
selecting the first part of obstacles from the plurality of obstacles according to the tasks;
acquiring the first predetermined movement rule corresponding to the first part of the obstacles according to the current task; and
changing the first part of the obstacles from the current movement trajectories to the first movement trajectories according to the first predetermined movement rule.

16. The computer equipment of claim 15, wherein changing the first part of the obstacles from the current movement trajectories to the first movement trajectories according to a first predetermined movement rule comprises:
acquiring speeds, accelerations, and positions of the first part of the obstacles at the current time;
calculating speeds, accelerations and positions of the first part of the obstacles at the next time according to the current task, and the speeds, the accelerations and the positions of the first part of the obstacles at the current time; and
planning first movement trajectories of the first part of the obstacles according to the speeds, the accelerations and the positions of the first part of the obstacles at the next time.

17. The computer equipment of claim of claim 16, wherein planning first movement trajectories of the first part of the obstacles according to the speeds, the accelerations and the positions of the first part of the obstacles at the next time comprises:
determining the positions of the first part of the obstacles at the next time according to the number of the first part of the obstacles;
adjusting the speeds and the accelerations of the obstacles at the positions at the next time to obtain speeds and the accelerations at the next time; and
planning first movement trajectories of the first part of the obstacles according to the adjusted speeds, the adjusted accelerations, and determined the position.

18. The computer equipment of claim 11, wherein the autonomous driving system includes a plurality of the tasks to be tested, loading the virtual autonomous vehicle to the simulation scene comprises:
acquiring a current task from the plurality of the task;
selecting one or more of the autonomous driving units corresponding to the current task; and
loading the one or more of the autonomous driving units to the simulation scene.

19. The computer equipment of claim 11, wherein the autonomous driving system includes a plurality of tasks to be tested, changing the second part of the obstacles from current movement trajectories to the second movement trajectories according to a second predetermined movement rule comprises:
acquiring a current task from the plurality of the tasks;
selecting the second part of obstacles from the plurality of obstacles according to the current task;
calculating a corresponding second predetermined movement rule of the second part of the obstacles according to the current task to be tested, and
changing the second part of the obstacles from the current movement trajectories to the second movement trajectories according to the second predetermined movement rule.

20. The computer equipment of claim 11, wherein the first event is that traffic lights change; the second event is that the first part of the obstacles dose not follow traffic rules.
